(19) United States
(12) Patent Application Publication
(10) Pub. No.: US 2025/0247729 A1
(43) Pub. Date: Jul. 31, 2025

(54) CAPABILITY BASED RECEIVED SIGNAL STRENGTH INDICATOR MEASUREMENT FOR NEW RADIO UNLICENSED

(71) Applicant: APPLE INC., Cupertino, CA (US)

(72) Inventors: Jie Cui, San Jose, CA (US); Dawei Zhang, Saratoga, CA (US); Hong He, San Jose, CA (US); Yang Tang, San Jose, CA (US); Yuexia Song, Beijing (CN); Yuqin Chen, Beijing (CN); Manasa Raghavan, Sunnyvale, CA (US); Qiming Li, Beijing (CN); Xiang Chen, Campbell, CA (US); Rolando E Bettancourt Ortega, Munich (DE)

(21) Appl. No.: 18/996,209

(22) PCT Filed: Jul. 21, 2023
(86) PCT No.: PCT/US2023/070670

§ 371 Date: Jan. 17, 2025

Related U.S. Application Data
(60) Provisional application No. 63/370,568, filed on Aug. 5, 2022.

(51) Int. Cl. H04W 24/10; H04W 8/24

(52) U.S. Cl. CPC H04W 24/10; H04W 8/24

(57) ABSTRACT

Wireless communication systems may include network nodes capable of requesting a capability of a user equipment (UE) for new radio (NR) Received Signal Strength Indicator (RSSI) and measurement channel occupancy (CO) measurements. One or both of the master node and the secondary node are configured to request, from the UE, a capability of the UE for NR Received Signal Strength Indicator (RSSI) and measurement channel occupancy (CO) measurements. The master node and the secondary node may coordinate the capability of the UE.

### TECHNICAL FIELD

This application relates generally to wireless communication systems, including coordination of UE capability for RSSI measurement.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a first signal flow diagram of a network for UE NR RSSI/CO measurement capability coordination according to some embodiments.

FIG. 2 illustrates a second signal flow diagram of a network for UE NR RSSI/CO measurement capability coordination according to some embodiments.

FIG. 3 illustrates a third signal flow diagram of a network for UE NR RSSI/CO measurement capability coordination according to some embodiments.

FIG. 4 illustrates a fourth signal flow diagram of a network for UE NR RSSI/CO measurement capability coordination according to some embodiments.

FIG. 5 illustrates a flow chart of a method for a UE to determine RSSI measurement duration.

FIG. 6 illustrates a measurement period design for inter-RAT RSSI measurements with gaps according to some embodiments.

FIG. 7 illustrates a measurement period design for measurement gapless inter-RAT RSSI measurements according to some embodiments.

FIG. 8 illustrates a measurement period design for measurement gapless inter-RAT RSSI measurements according to some embodiments.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Some of the goals of wireless network communication systems are to improve reliability and increase bandwidth. New Radio Unlicensed (NR-U) is one way in which cellular operators are seeking to accomplish these goals. NR-U is a mode of operation that cellular operators may use to integrate the unlicensed spectrum into 5G networks.

In a NR-U system, a UE may perform a Received Signal Strength Indicator (RSSI) measurement. The RSSI is used to find out if the load on a carrier channel is already high. Because the NR-U uses the unlicensed spectrum, the system load may be high due to hotspots occupying the channel and competing with the NR-U system. If the load is high, the network may choose to schedule transmissions on another carrier.

The capability to perform RSSI measurement is optional for UEs. Additionally, the reporting of whether the UE supports RSSI measurement is different depending on the release standard. For example, for RSSI and channel occupancy (CO) measurement in Release 16 (R16), the UE uses a field (rssi-ChannelOccupancy Reporting-r16) to indicate to the NR side of the network whether the UE supports RSSI measurements and channel occupancy reporting. However, the UE only reports this variable to the NR side of the network. In release 16 this is the only mechanism the UE has to indicate this capability. However, this leads to a gap between the NR side of the network and the LTE side of the network, because the LTE side doesn't have the knowledge about the UE.

In Release 17 (R17), RSSI measurements and channel occupancy reporting capability is indicated by the UE in the field nr-RSSI-ChannelOccupancy Reporting-r17. This field indicates whether the UE supports performing measurements and reporting of RSSI and channel occupancy on the corresponding NR band. If both sharedSpectrumMeasNR-EN-DC-r17 and sharedSpectrumMeasNR-SA-r17 are included, the UE shall set the value of nr-RSSI-ChannelOccupancy Reporting-r17 consistently for the same NR band. However, this indication is not shared between LTE and NR sides of the network.

It is therefore desirable in Release 16 network, for a method that allows an LTE primary cell (PCell) or NR primary secondary cells (PSCell) to understand the UE capability of RSSI and CO measurement before configuring the RMTC (RSSI Measurement Timing Configuration). Further, it is desirable in Release 17 E-UTRAN-NR Dual Connectivity (EN-DC), to have NR PSCell understand the UE capability of RSSI and CO measurement before configuring the RMTC (RSSI Measurement Timing Configuration). Some embodiments herein provide coordination between nodes. Some embodiments herein allow the nodes to have the flexibility to request that the UE indicate the capability of RSSI and CO measurement.

Another issue faced by NR-U networks is inter-radio access technology (RAT) RSSI and CO measurement in EN-DC mode. An inter-RAT measurement is a measurement performed on a RAT different from the RAT of the current cell. In EN-DC mode, there may be two kinds of configuration from network.

In a first scenario, the LTE side of the network would like the UE to do measurements for the NR side of the network. For example, in the first scenario inter-RAT RSSI and CO measurement in EN-DC is configured on a non-serving NR carrier or radio resource measurement (RRM) measurement and timing configuration (rmtc)-Frequency (the center frequency of the RSSI and CO measured bandwidth) is outside UE active bandwidth part (BWP), the measurement gap (MG) is used and MG based RSSI and CO measurement period design may be used.

In a second scenario, the LTE side of a network may configure the UE to perform an inter-RAT RSSI and CO measurement on the NR side of the network. In the second scenario, inter-RAT RSSI and CO measurement in EN-DC is configured on a serving NR carrier or rmtc-Frequency (the center frequency of the RSSI and CO measured bandwidth) is inside UE active BWP, the gapless RSSI and CO measurement period design may be used.

The current speciation fails to consider both of these scenarios for NR-U RSSI measurement in EN-DC mode. For example, the current Spec assumes that the MG is always used. As shown by the identified scenarios, a MG may not be used in some situations in NR inter-RAT RSSI and CO measurements. Some embodiments herein comprise a gapless RSSI and CO measurement period design.

The current NR-U RSSI measurement in EN-DC mode has been specified in TS36.133. In TS36.133, the UE physical layer shall be capable of performing the RSSI measurements, defined in TS 38.215 [58], on one or more inter-RAT carriers operating with CCA, TS 37.213 [57], if the carrier(s) are indicated by higher layers [38], and reporting the RSSI measurements to higher layers. The UE physical layer shall provide to higher layers a single RSSI sample for each OFDM symbol within each configured RSSI measurement duration occurring with a configured RSSI measurement timing configuration periodicity, rmtc-Periodicity, according to [38]. If the UE requires measurement gaps to perform inter-frequency measurements, a single measurement gap pattern is used for all concurrent inter-frequency measurements, including inter-frequency RSSI measurements. The RSSI measurement duration and the measurement gap should be aligned, and the following additional condition should be fulfilled: Entire RSSI measurement duration should be contained in the measurement gap. The RSSI measurement performed and reported according to this section shall meet the RSSI measurement accuracy requirement in Section TBD.

Additionally, some embodiments herein comprise an update to the measurement object (MO) merging rule. The current MO merging rule in EN-DC mode is specified as: when the E-UTRA PCell and PSCell configures the same NR carrier frequency layer to be monitored by the UE in synchronous intra-band EN-DC, this layer may be counted only once to the total number of effective carrier frequency layers provided that the SFN-s and slot boundaries are aligned, unless the configured NR carrier frequency layers to be monitored have one of the following conditions. Configured NR carrier frequency layers have different RSSI measurement resources. Configured NR carrier frequency layers have different deriveSSB-IndexFromCell indications. Configured NR carrier frequency layers have different synchronization signal block (SSB) measurement time configuration (SMTC) configurations. Configured NR carrier frequency layers have different ssb-PositionQCL-Common-r16 indications or cell list of ssb-PositionQCL on NR carrier frequency layer with clear channel assessment (CCA). Configured NR carrier frequency layers have different rmtc-Config-r16 indication on NR carrier frequency layer with CCA.

However, the network may interpret the UE capability in different ways depending on whether the wireless system is a R16 or R17 version. Further, the UE may report its capability in different ways based on whether the wireless system is a R16 or R17 version. Accordingly, it may be advantageous to have the merging rules be different for both the UE behavior and the network expectation for the R16 and R17 versions.

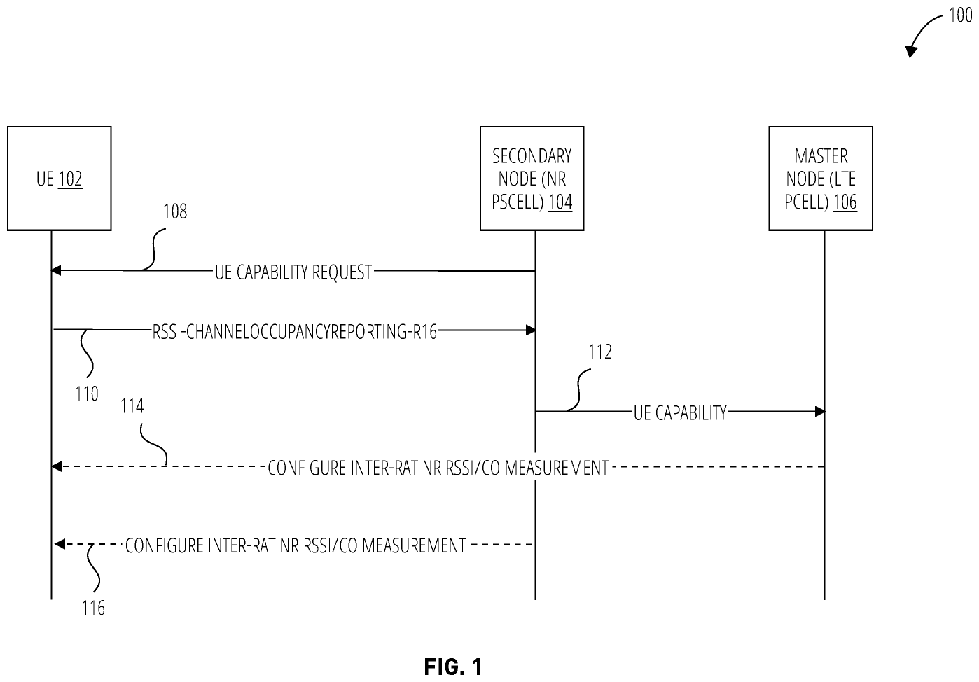

As discussed, R16 networks and R17 networks have different a UE capability indication for NR RSSI and CO measurement. As shown in FIGS. 1-4, different releases may have different coordination methods of the UE capability for the network because of the differences in R16 and R17 networks.

FIG. 1 illustrates a first signal flow diagram of a network 100 for UE NR RSSI/CO measurement capability coordination according to some embodiments. The UE 102 is operating in EN-DC mode and the network 100 is a R16 network with LTE PCell on the master node 106 and NR PSCell on the secondary node 104. In some embodiments, a master node may be connected to a UE in LTE standalone mode. In R16 only one type of capability indication exists and the indication is only sent to NR node (e.g., secondary node 204). Accordingly, the secondary node 104 may receive the UE capability and inform the master node 106 of the UE capability.

For example, the secondary node 104 may send a request 108 to the UE 102. The request 108 may inquire whether the UE 102 has the capability of NR RSSI and CO measurements. The UE 102 may transmit a report 110 of the capability to the secondary node 104 on the NR side of the network. The report 110 may comprise rssi-ChannelOccupancy Reporting-r16. The secondary node 104 receives the capability report 110 and passes or forwards the UE capability of NR RSSI/CO measurement 112 to the master node 106 on the LTE side of the network. Thus, the NR node may act as a relay to transmit the UE NR RSSI/CO measurement capability to the LTE node. In some embodiments, the rssi-ChannelOccupancy Reporting-r16 may be exactly relayed by the secondary node 104. In some embodiments, the secondary node 104 may generate a new field that contains the information to send to the master node 106.

Based on the UE capability, either the secondary node 104 or the master node 106 may configure the UE 102 for an inter-RAT NR RSSI/CO measurement. For example, the master node 106 may encode and send a configuration 114 to the UE 102 for the inter-RAT NR RSSI/CO measurement with RMTC based on the capability. Further, the secondary node 104 can also encode and send a configuration 116 to the UE 102 for the inter-RAT NR RSSI/CO measurement with RMTC based on the capability. The UE 102 may perform the inter-RAT NR RSSI/CO measurement based on the configuration.

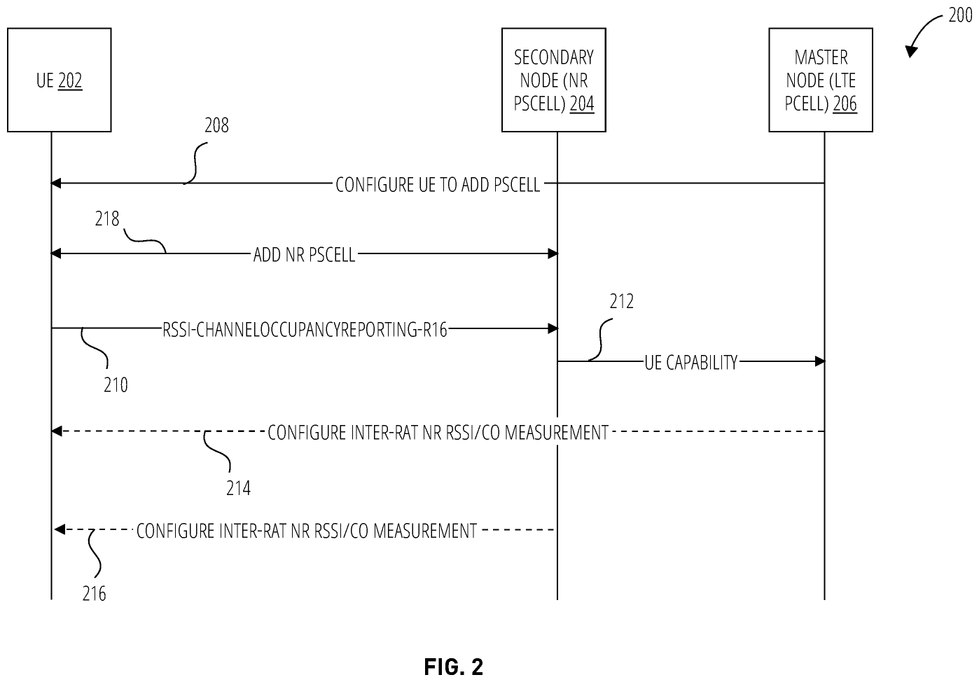

FIG. 2 illustrates a second signal flow diagram of a network 200 for UE NR RSSI/CO measurement capability coordination according to some embodiments. The UE 202 is operating in EN-DC mode and the network 200 is a R16 network with LTE PCell on the master node 206 and NR PSCell on the secondary node 204. In R16 only one type of capability indication exists and the indication is only sent to NR node (e.g., secondary node 204). Accordingly, the secondary node 204 may receive the UE capability and inform the master node 206 of the UE capability.

For example, the master node 206 may send a PSCell configuration 208 to the UE 202. The PSCell configuration 208 may be used to configure the UE 202 to add a PSCell (e.g., NR PSCell on secondary node 204) under secondary node. The UE 202 may perform a procedure 218 to add a PSCell according to the PSCell configuration 208.

The UE 202 reports rssi-ChannelOccupancy Reporting-r16 to SN after PSCell addition. For example, the UE 202 may transmit a report 210 of the capability to the secondary node 204 on the NR side of the network. The report 210 may comprise the rssi-ChannelOccupancy Reporting-r16. The secondary node 204 receives the capability report 210 and passes or forwards the UE capability of NR RSSI/CO measurement 212 to the master node 206 on the LTE side of the network. Thus, the NR node may act as a relay to transmit the UE NR RSSI/CO measurement capability to the LTE node. In some embodiments, the rssi-ChannelOccupancyReporting-r16 may be exactly relayed by the secondary node 204. In some embodiments, the secondary node 204 may generate a new field that contains the information to send to the master node 206.

Based on the UE capability, either the secondary node 204 or the master node 206 may configure the UE 202 for an inter-RAT NR RSSI/CO measurement. For example, the master node 206 may encode and send a configuration 214 to the UE 202 for the inter-RAT NR RSSI/CO measurement with RMTC based on the capability. Further, the secondary node 204 can also encode and send a configuration 216 to the UE 202 for the inter-RAT NR RSSI/CO measurement with RMTC based on the capability. The UE 202 may perform the inter-RAT NR RSSI/CO measurement based on the configuration.

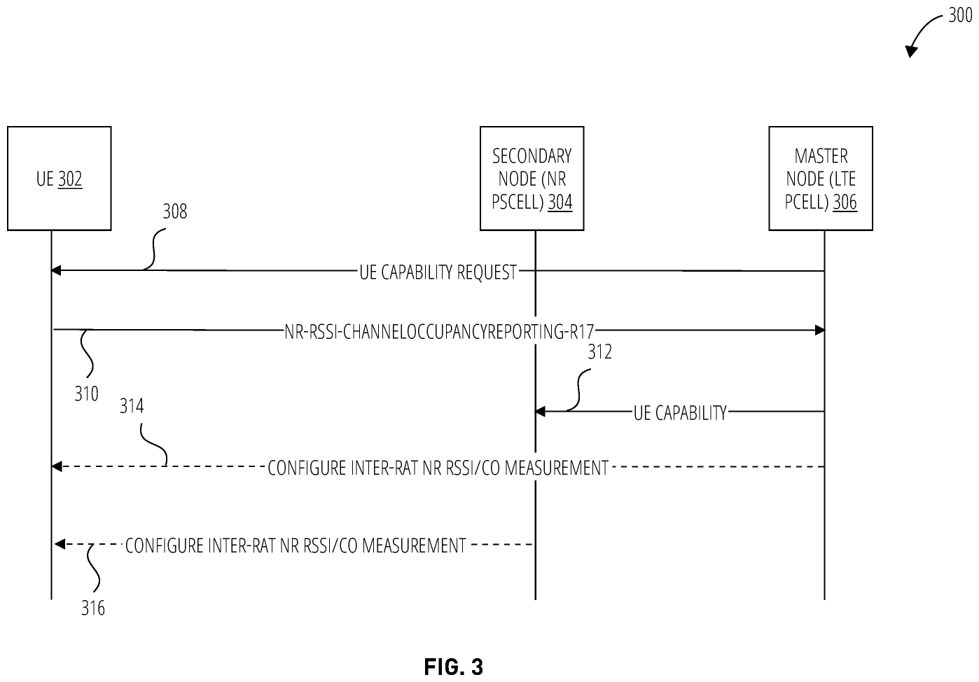

FIG. 3 illustrates a third signal flow diagram of a network 300 for UE NR RSSI/CO measurement capability coordination according to some embodiments. The UE 302 is operating in EN-DC mode and the network 300 is a R17 network with LTE PCell on the master node 306 and NR PSCell on the secondary node 304.

R17 networks have two types of signaling for reporting UE NR RSSI/CO measurement capability. In R17, the UE 302 can report nr-RSSI-ChannelOccupancy Reporting-r17 to the LTE side of the network 300, and rssi-ChannelOccupancy Reporting-r16 to the NR side of the network 300. In some embodiments, the master node 306 may receive the UE capability and inform the secondary node 304 of the UE capability.

For example, the master node 306 may send a request 308 to the UE 302. The request 308 may inquire whether the UE 302 has the capability of NR RSSI and CO measurements. The UE 302 may transmit a report 310 of the capability to the master node 306 on the LTE side of the network. The report 310 may comprise nr-RSSI-ChannelOccupancy Reporting-r17. The master node 306 receives the capability report 310 and passes or forwards the UE capability of NR RSSI/CO measurement 312 to the secondary node 304 on the LTE side of the network. Thus, the LTE node may act as a relay to transmit the UE NR RSSI/CO measurement capability to the NR node. In some embodiments, the nr-RSSI-ChannelOccupancy Reporting-r17 may be relayed by the master node 306. In some embodiments, the master node 306 may generate a new field that contains the information to send to the secondary node 304

Based on the UE capability, either the secondary node 304 or the master node 306 may configure the UE 302 for an inter-RAT NR RSSI/CO measurement. For example, the master node 306 may encode and send a configuration 314 to the UE 302 for the inter-RAT NR RSSI/CO measurement with RMTC based on the capability. Further, the secondary node 304 can also encode and send a configuration 316 to the UE 302 for the inter-RAT NR RSSI/CO measurement with RMTC based on the capability. The UE 302 may perform the inter-RAT NR RSSI/CO measurement based on the configuration.

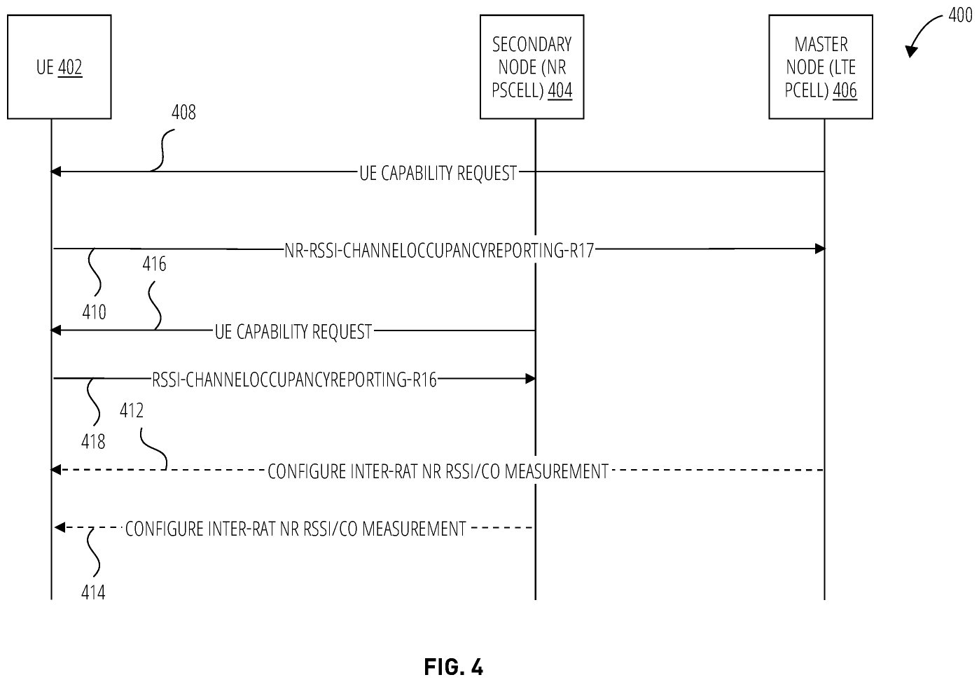

FIG. 4 illustrates a fourth signal flow diagram of a network 400 for UE NR RSSI/CO measurement capability coordination according to some embodiments. The UE 402 is operating in EN-DC mode and the network 400 is a R17 network with LTE PCell on the master node 406 and NR PSCell on the secondary node 404.

R17 networks have two types of signaling for reporting UE NR RSSI/CO measurement capability. In R17, the UE 402 can report nr-RSSI-ChannelOccupancy Reporting-r17 to the LTE side of the network 400, and rssi-ChannelOccupancy Reporting-r16 to the NR side of the network 400. In some embodiments, both the master node 406 and the secondary node 404 may individually request and receive the UE capability. The UE 402 may report a different type of capability to the master node 406 and secondary node 404: rssi-ChannelOccupancyReporting-r16 to secondary node 404; and nr-RSSI-ChannelOccupancyReporting-r17 to master node 406.

For example, the master node 406 may send a request 408 to the UE 402. The request 408 may inquire whether the UE 402 has the capability of NR RSSI and CO measurements. The UE 402 may transmit a report 410 of the capability to the master node 406 on the LTE side of the network. The report 410 may comprise nr-RSSI-ChannelOccupancy Reporting-r17.

The secondary node 404 may send a request 416 to the UE 402. The request 408 may inquire whether the UE 402 has the capability of NR RSSI and CO measurements. The UE 402 may transmit a report 418 of the capability to the secondary node 404 on the NR side of the network. The report 418 may comprise rssi-ChannelOccupancy Reporting-r16.

Based on the UE capability, either the secondary node 404 or the master node 406 may configure the UE 402 for an inter-RAT NR RSSI/CO measurement. For example, the master node 406 may encode and send a configuration 412 to the UE 402 for the inter-RAT NR RSSI/CO measurement with RMTC based on the capability. Further, the secondary node 404 can also encode and send a configuration 414 to the UE 402 for the inter-RAT NR RSSI/CO measurement with RMTC based on the capability. The UE 402 may perform the inter-RAT NR RSSI/CO measurement based on the configuration.

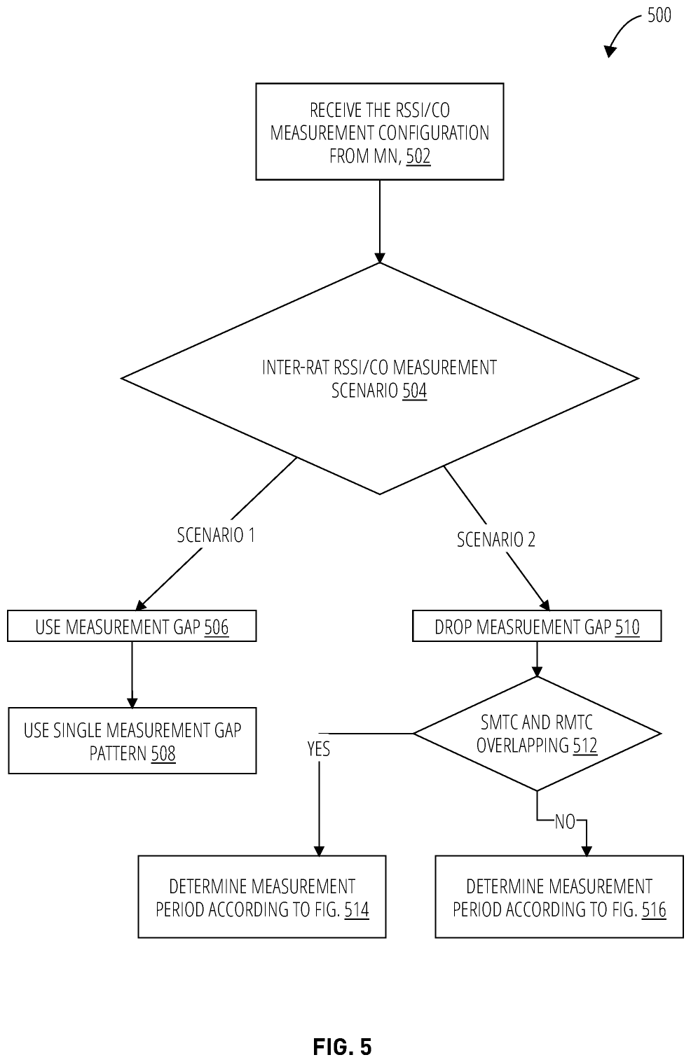

FIG. 5 illustrates a flow chart of a method 500 for a UE to determine RSSI measurement duration. This method 500 may be used while the UE is in EN-DC mode. The UE may receive 502 the RSSI/CO measurement configuration from master node.

After the RSSI/CO measurement configuration is received, the UE may determine 504 the scenario of RSSI/CO measurement between a first scenario and a second scenario. The first scenario occurs when the inter-RAT RSSI/CO measurement in EN-DC is configured on a non-serving NR carrier or rmtc-Frequency (the center frequency of the RSSI/CO measured bandwidth) is outside UE active BWP or RSSI measurement bandwidth cannot be covered by UE active BWP. If the UE determines that the first scenario occurs, then the UE may use 506 a measurement gap and measurement gap based RSSI/CO measurement.

The second scenario occurs when the inter-RAT RSSI/CO measurement in EN-DC is configured on a serving NR carrier or rmtc-Frequency (the center frequency of the RSSI/CO measured bandwidth) is inside UE active BWP or RSSI measurement bandwidth is fully within UE active BWP. If the UE determines that the second scenario occurs, then the UE may drop 510 the measurement gap for RSSI/CO measurement and use a measurement gapless RSSI/CO measurement.

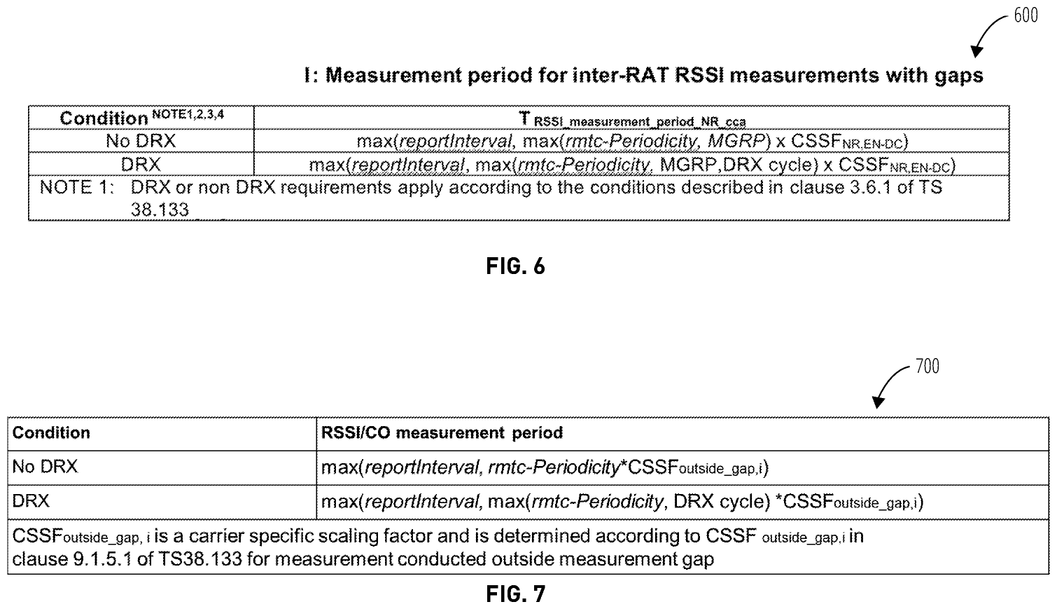

For the first scenario, the UE may require measurement gaps to perform inter_RAT measurements. The UE may use 508 a single measurement gap pattern for all concurrent inter-frequency and inter-RAT measurements, including inter-RAT NR RSSI measurements. The inter-RAT NR RSSI measurement duration and the measurement gap may be aligned, and the entire RSSI measurement duration may be contained in the measurement gap. The measurement period may be determined as shown in FIG. 6.

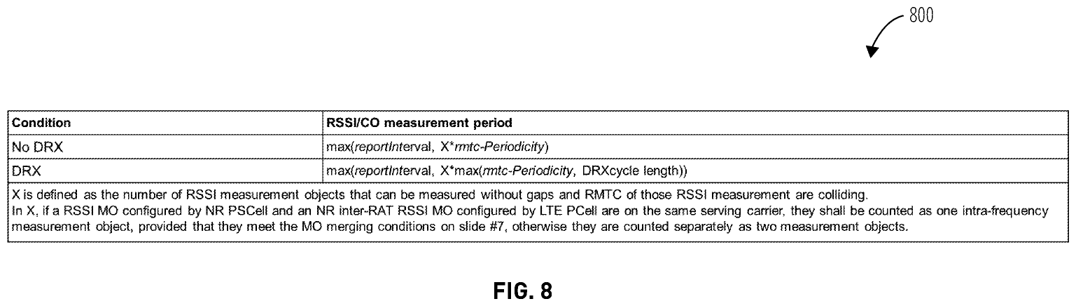

For the second scenario, the UE measurement period may be based on whether the SMTC and RMTC are overlapping or not overlapping. The UE may determine 512 if the SMTC and RMTC are overlapping. If the SMTC and RMTC are overlapping, the UE determines 514 that the measurement period design for inter-RAT RSSI measurements as configured by LTE MN is as shown in FIG. 7. If the SMTC and RMTC are not overlapping, the UE determines 516 that the measurement period design for inter-RAT RSSI measurements as configured by LTE MN is as shown in FIG. 8.

FIG. 6 illustrates a measurement period design 600 for inter-RAT RSSI measurements with gaps. As shown, the measurement duration may be different based on whether there is Discontinuous Reception (DRX) or no DRX. If there is no DRX, the measurement duration may be max(reportInterval, max(rmtc-Periodicity, MGRP) X CSSFNR,EN-DC). For occasions with DRX, the measurement duration may be max(reportInterval, max(rmtc-Periodicity, MGRP, DRX cycle) X CSSF_{NR,EN-DC}).

FIG. 7 illustrates a measurement period design 700 for measurement gapless inter-RAT RSSI measurements. Specifically, the measurement period design 700 may be for occurrences where SMTC and RMTC are overlapping. The measurement period may be derived using the functions shown based on the DRX condition. If the condition is no DRX, the RSSI/CO measurement period may be max(reportInterval, rmtc-Periodicity*CSSF_{outside_gap,i}). The CSSF_{outside_gap,i} variable is a carrier specific scaling factor and may be determined according to CSSF_{outside_gap,i} in clause 9.1.5.1 of TS38.133 for measurement conducted outside measurement gap. If there is DRX, the RSSI/CO measurement period may be max(reportInterval, max(rmtc-Periodicity, DRX cycle) *CSSF_{outside_gap,i}).

FIG. 8 illustrates a measurement period design 800 for measurement gapless inter-RAT RSSI measurements. Specifically, the measurement period design 700 may be for occurrences where SMTC and RMTC are not overlapping. The measurement period may be derived using the functions shown based on the DRX condition. If the condition is no DRX, the RSSI/CO measurement period may be max(reportInterval, X*rmtc-Periodicity). If there is DRX, the RSSI/CO measurement period may be max(reportInterval, X*max(rmtc-Periodicity, DRXcycle length)).

X is defined as the number of RSSI measurement objects that can be measured without gaps and RMTC of those RSSI measurement are colliding. In X, if a RSSI MO configured by NR PSCell and an NR inter-RAT RSSI MO configured by LTE PCell are on the same serving carrier, they shall be counted as one intra-frequency measurement object, provided that they meet the MO merging conditions, otherwise they are counted separately as two measurement objects.

For a R16 wireless communication system, the MO merging rule in EN-DC mode may be that when the E-UTRA PCell and PSCell configures the same NR carrier frequency layer to UE for RSSI/CO measurement objects in synchronous intra-band EN-DC, this layer may be counted only once to the total number of effective carrier frequency layers provided that the SFN-s and slot boundaries are aligned, and meet following conditions, regardless of rmtc-Config-r16 indication on NR carrier frequency layer with CCA. The conditions to determine whether the MO may be merged include same RSSI measurement resources, same deriveSSB-IndexFromCell indications, same SMTC configurations, and same ssb-PositionQCL-Common-r16 indications or cell list of ssb-PositionQCL on NR carrier frequency layer with CCA.

For a R17 wireless communication system, the MO merging rule in EN-DC mode may be that when the E-UTRA PCell and PSCell configures the same NR carrier frequency layer to be monitored by the UE in synchronous intra-band EN-DC, this layer may be counted only once to the total number of effective carrier frequency layers provided that the SFN-s and slot boundaries are aligned, and meet following conditions. The conditions to determine whether the MO may be merged include: same RSSI measurement resources; same deriveSSB-IndexFromCell indications; same SMTC configurations; same ssb-PositionQCL-Common-r16 indications or cell list of ssb-PositionQCL on NR carrier frequency layer with CCA; and same rmtc-Config-r16 indication on NR carrier frequency layer with CCA if UE indicates that it supports ChannelOccupancy Reporting-r17 in both sharedSpectrumMeasNR-EN-DC-r17 and sharedSpectrumMeasNR-SA-r17, otherwise regardless of rmtc-Config-r16 indication on NR carrier frequency layer with CCA.

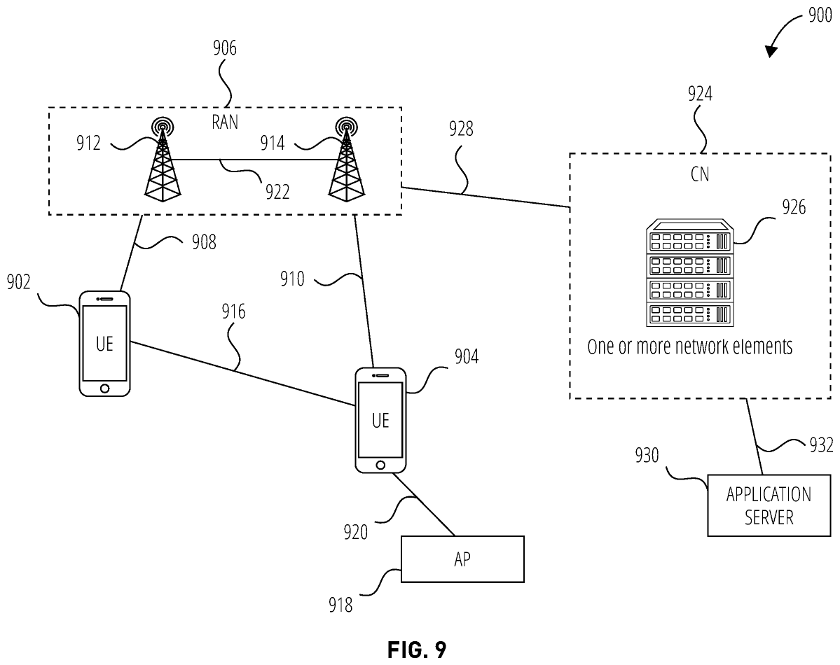

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VOIP sessions, group communication sessions, etc.) for the UE 902 and UE 904 via the CN 924. The application server 930 may communicate with the CN 924 through an IP communications interface 932.

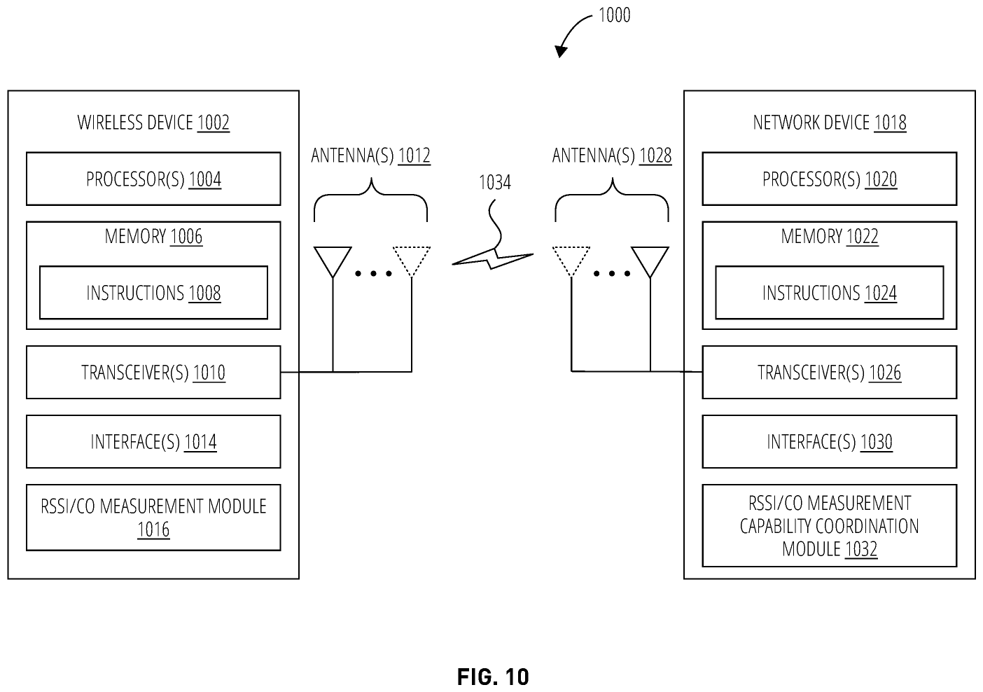

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include an RSSI/CO measurement module 1016. The RSSI/CO measurement module 1016 may be implemented via hardware, software, or combinations thereof. For example, the RSSI/CO measurement module 1016 may be implemented as a processor, circuit, and/or instructions 1008 stored in the memory 1006 and executed by the processor(s) 1004. In some examples, the RSSI/CO measurement module 1016 may be integrated within the processor(s) 1004 and/or the transceiver(s) 1010. For example, the RSSI/CO measurement module 1016 may be implemented by a combination of software components (e.g., executed by a DSP or a general processor) and hardware components (e.g., logic gates and circuitry) within the processor(s) 1004 or the transceiver(s) 1010.

The RSSI/CO measurement module 1016 may be used for various aspects of the present disclosure, for example, aspects of FIGS. 1-7. The RSSI/CO measurement module 1016 is configured to perform an inter-RAT NR RSSI/CO measurement.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include an RSSI/CO measurement capability coordination module 1032. The RSSI/CO measurement capability coordination module 1032 may be implemented via hardware, software, or combinations thereof. For example, the RSSI/CO measurement capability coordination module 1032 may be implemented as a processor, circuit, and/or instructions 1024 stored in the memory 1022 and executed by the processor(s) 1020. In some examples, the RSSI/CO measurement capability coordination module 1032 may be integrated within the processor(s) 1020 and/or the transceiver(s) 1026. For example, the RSSI/CO measurement capability coordination module 1032 may be implemented by a combination of software components (e.g., executed by a DSP or a general processor) and hardware components (e.g., logic gates and circuitry) within the processor(s) 1020 or the transceiver(s) 1026.

The RSSI/CO measurement capability coordination module 1032 may be used for various aspects of the present disclosure, for example, aspects of FIGS. 1-4. The RSSI/CO measurement capability coordination module 1032 is configured to request UE capability regarding NR/RSSI/CO measurement, coordinate the UE capability with additional network devices, and configure an inter-RAT NR RSSI/CO measurement.

Embodiments contemplated herein include an apparatus comprising means to perform one or more elements of the method 500 and signal flow diagrams shown in FIGS. 1-4. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 500 and signal flow diagrams shown in FIGS. 1-4. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 500 and signal flow diagrams shown in FIGS. 1-4. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 500 and signal flow diagrams shown in FIGS. 1-4. This apparatus may be, for example, an apparatus of a UE (such as a wireless device 1002 that is a UE, as described herein).

Embodiments contemplated herein include a signal as described in or related to one or more elements of the method 500 and signal flow diagrams shown in FIGS. 1-4.

Embodiments contemplated herein include a computer program or computer program product comprising instructions, wherein execution of the program by a processor is to cause the processor to carry out one or more elements of the method 500 and signal flow diagrams shown in FIGS. 1-4. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of the signal flow diagrams shown in FIGS. 1-4. This apparatus may be, for example, an apparatus of a base station (such as a network device 1018 that is a base station, as described herein).

Embodiments contemplated herein include one or more non-transitory computer-readable media comprising instructions to cause an electronic device, upon execution of the instructions by one or more processors of the electronic device, to perform one or more elements of the signal flow diagrams shown in FIGS. 1-4. This non-transitory computer-readable media may be, for example, a memory of a base station (such as a memory 1022 of a network device 1018 that is a base station, as described herein).

Embodiments contemplated herein include an apparatus comprising logic, modules, or circuitry to perform one or more elements of the signal flow diagrams shown in FIGS. 1-4. This apparatus may be, for example, an apparatus of a base station (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of the signal flow diagrams shown in FIGS. 1-4. This apparatus may be, for example, an apparatus of a base station (such as a network device 1018 that is a base station, as described herein).

Embodiments contemplated herein include a signal as described in or related to one or more elements of the signal flow diagrams shown in FIGS. 1-4.

Embodiments contemplated herein include a computer program or computer program product comprising instructions, wherein execution of the program by a processing element is to cause the processing element to carry out one or more elements of the signal flow diagrams shown in FIGS. 1-4. The processor may be a processor of a base station (such as a processor(s) 1020 of a network device 1018 that is a base station, as described herein). These instructions may be, for example, located in the processor and/or on a memory of the base station (such as a memory 1022 of a network device 1018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network system, the method comprising:
connecting a master node and a secondary node to a user equipment (UE) in Evolved Universal Terrestrial Radio Access Network (E-UTRAN) New Radio (NR)—Dual Connectivity (EN-DC) mode, or connecting the master node to the UE in LTE standalone mode;
determining capability of the UE for NR Received Signal Strength Indicator (RSSI) and measurement channel occupancy (CO) measurements at both the secondary node and the master node;
encoding, via the secondary node or the master node, a configuration for inter-radio access technology (RAT) NR RSSI and CO measurement; and
transmitting, via the secondary node or the master node, the configuration to the UE.

2. The method of claim 1, further comprising:
requesting, from the secondary node, the capability of the UE;
receiving from the UE, at the secondary node, a rssi-ChannelOccupancyReporting-r16 field indicating the capability of the UE; and
passing the capability of the UE from the secondary node to the master node.

3. The method of claim 1, further comprising:
configuring, via the master node, the UE to add a primary secondary cell (PSCell) under the secondary node;
receiving, at the secondary node, from the UE after addition of the PSCell, a rssi-ChannelOccupancyReporting-r16 field indicating the capability of the UE; and
passing the capability of the UE from the secondary node to the master node.

4. The method of claim 1, further comprising:
requesting, from the master node, the capability of the UE;
receiving from the UE, at the master node, a nr-RSSI-ChannelOccupancyReporting-r17 field indicating the capability of the UE; and
passing the capability of the UE from the master node to the secondary node.

5. The method of claim 1, further comprising:
requesting, from the master node, the capability of the UE;
receiving from the UE, at the master node, a nr-RSSI-ChannelOccupancyReporting-r17 field indicating the capability of the UE;
requesting, from the secondary node, the capability of the UE; and
receiving from the UE, at the secondary node, a rssi-ChannelOccupancyReporting-r16 field indicating the capability of the UE.

6. The method of claim 1, further comprising merging measurement objects when a same NR carrier frequency layer is configured for RSSI and CO measurement objects in synchronous intra-band EN-DC, when the measurement objects have:
same RSSI measurement resources,
same deriveSSB-IndexFromCell indications,
same SMTC configurations, and
same ssb-PositionQCL-Common-r16 indications or cell list of ssb-PositionQCL on the same NR carrier frequency layer with clear channel assessment (CCA).

7. The method of claim 1, further comprising merging measurement objects when a same NR carrier frequency layer is configured to be monitored by the UE in synchronous intra-band EN-DC, when the measurement objects have:
same RSSI measurement resources,
same deriveSSB-IndexFromCell indications,
same SMTC configurations,
same ssb-PositionQCL-Common-r16 indications or cell list of ssb-PositionQCL on the same NR carrier frequency layer with clear channel assessment (CCA), and
same rmtc-Config-r16 indication on the same NR carrier frequency layer with the CCA if the UE indicates to support ChannelOccupancy Reporting-r17 in both sharedSpectrumMeasNR-EN-DC-r17 and sharedSpectrumMeasNR-SA-r17, otherwise regardless of the rmtc-Config-r16 indication on the same NR carrier frequency layer with the CCA.

8. A method for a user equipment (UE), the method comprising:
connecting to a master node and a secondary node in Evolved Universal Terrestrial Radio Access Network (E-UTRAN) New Radio (NR)—Dual Connectivity (EN-DC) mode or connecting the master node to the UE in LTE standalone mode;
reporting a capability of the UE for NR Received Signal Strength Indicator (RSSI) and measurement channel occupancy (CO) measurements to one or both of the master node and the secondary node;
receiving a configuration for inter-radio access technology (RAT) NR RSSI and CO measurement;
determining whether a measurement gap should be used for the inter-RAT RSSI and the CO measurement; and
measuring inter-RAT RSSI and CO.

9. The method of claim 8, further comprising:
receiving a request, from the secondary node, regarding the capability of the UE; and
sending to the secondary node a rssi-ChannelOccupancyReporting-r16 field indicating the capability of the UE passing the capability of the UE from the secondary node to the master node.

10. The method of claim 8, further comprising:
adding a primary secondary cell (PSCell) under the secondary node; and
sending, to the secondary node after addition of the PSCell, a rssi-ChannelOccupancyReporting-r16 field indicating the capability of the UE.

11. The method of claim 8, further comprising:
receiving a request, from the master node, regarding the capability of the UE; and
sending to the master node a nr-RSSI-ChannelOccupancyReporting-r17 field indicating the capability of the UE.

12. The method of claim 8, further comprising:
receiving a request, from the secondary node, regarding the capability of the UE;
sending to the secondary node a rssi-ChannelOccupancyReporting-r16 field indicating the capability of the UE passing the capability of the UE from the secondary node to the master node;
receiving a second request, from the master node, regarding the capability of the UE; and
sending to the master node a nr-RSSI-ChannelOccupancyReporting-r17 field indicating the capability of the UE.

13. The method of claim 8, wherein a gap based measurement is used when the inter-RAT RSSI and the CO measurement in EN-DC is configured on a non-serving NR carrier or radio resource measurement (RRM) measurement and timing configuration (rmtc)-Frequency is outside active bandwidth-part (BWP) or RSSI measurement bandwidth cannot be covered by active BWP.

14. The method of claim 8, wherein a gapless measurement is used when the inter-RAT RSSI and the CO measurement in EN-DC is configured on a serving NR carrier or radio resource measurement (RRM) measurement and timing configuration (rmtc)-Frequency is inside active bandwidth-part (BWP) or RSSI measurement bandwidth is fully within active BWP.

15. The method of claim 8, further comprising determining a measurement period, wherein the measurement period varies based on whether a gap based measurement or a gapless measurement is used.

16. The method of claim 8, further comprising determining a measurement period, wherein the measurement period varies based on a Discontinuous Reception (DRX) condition.

17. The method of claim 8, further comprising merging measurement objects when a same NR carrier frequency layer is configured for RSSI and CO measurement objects in synchronous intra-band EN-DC, when the measurement objects have:
same RSSI measurement resources,
same deriveSSB-IndexFromCell indications,
same SMTC configurations, and
same ssb-PositionQCL-Common-r16 indications or cell list of ssb-PositionQCL on the same NR carrier frequency layer with clear channel assessment (CCA).

18. The method of claim 8, further comprising merging measurement objects when a same NR carrier frequency layer is configured to be monitored by the UE in synchronous intra-band EN-DC, when the measurement objects have:
same RSSI measurement resources,
same deriveSSB-IndexFromCell indications,
same SMTC configurations,
same ssb-PositionQCL-Common-r16 indications or cell list of ssb-PositionQCL on the same NR carrier frequency layer with clear channel assessment (CCA), and
same rmtc-Config-r16 indication on the same NR carrier frequency layer with the CCA if the UE indicates to support ChannelOccupancy Reporting-r17 in both sharedSpectrumMeasNR-EN-DC-r17 and sharedSpectrumMeasNR-SA-r17, otherwise regardless of the rmtc-Config-r16 indication on the same NR carrier frequency layer with the CCA.

19-21. (canceled)

22. A wireless communication system, the system comprising:
a user equipment (UE);
a master node; and
a secondary node,
wherein the UE is connected to the master node and the secondary node in Evolved Universal Terrestrial Radio Access Network (E-UTRAN) New Radio (NR)—Dual Connectivity (EN-DC) mode, and
wherein one or both of the master node and the secondary node are configured to request, from the UE, a capability of the UE for NR Received Signal Strength Indicator (RSSI) and measurement channel occupancy (CO) measurements.

23. The wireless communication system of claim 22, wherein the master node passes the capability of the UE to the secondary node.

24. (canceled)
